(19) United States
(12) Patent Application Publication
(10) Pub. No.: US 2006/0213160 A1
(43) Pub. Date: Sep. 28, 2006

(54) Air inlet for a two-stage dust collecting machine

(75) Inventor: Chieh-Yuan Cheng, Taichung (TW)

Correspondence Address: TROXELL LAW OFFICE PLLC;SUITE 1404, 5205 LEESBURG PIKE, FALLS CHURCH, VA, 22041, US

(73) Assignee: San Ford Machinery Co., Ltd.

(21) Appl. No.: 11/088,795

(22) Filed: Mar. 25, 2005

(51) Int. Cl. B01D 45/12

(52) U.S. Cl. 55/459.4

(57) ABSTRACT

An air inlet for a two-stage dust collecting machine is formed in an air-pipe housing in a two stage dust collecting machine, and the air inlet is an rectangular shape formed in the annular wall of the air-pipe housing in the tangent direction. Further, a rectangular pipe is provided to extend out from the rectangular inlet, a circular pipe extends out from the rectangular pipe, and a current guiding member extends inward from the rectangular inlet. Therefore, sucked-in air is guided through the rectangular pipe with a comparative large space to flow through the current guiding member to become a helical current moving along the inner surface of the air-pipe housing, so sucked-in air flows smoothly in the machine, upgrading the two-stage dust collecting function of the machine.

### BACKGROUND OF THE INVENTION

1. Field of the Invention

This invention relates to a two-stage dust collecting machine, particularly to one provided with an air inlet possible to lower resistance against air sucked in and to form smooth helical air current in an air-pipe housing for upgrading two-stage dust collecting function of the machine.

2. Description of the Prior Art

A conventional known two-stage dust collecting machine shown in FIG. 1 generally includes a fan housing 11, a rotary fan 13 fixed in the fan housing and driven by a motor 12, a second air exit 111 formed in the fan housing 11 and communicating with a dust bag 14, and a air pipe 15 connected with the bottom of the fan housing 11. Further, an air-pipe housing 16 is fitted around the air pipe 15 with an annular gap and fixed with the bottom of the fan housing 11, and a dust collecting tank 17. The air-pipe housing 16 has an air inlet 161 in its sidewall, and a first air exit 162 in the bottom connected with the dust collect tank 17. So dust is sucked through the air inlet 161, out of the first air exit 162 into the dust-collecting tank 17 for collected for the first stage. Then smaller bits of dust are sucked through the air pipe 15 via the second air exit 111 into the dust-collecting bag 14 for the second stage. The air inlet 161 is connected with a circular tube 163 fixed sidewise with the sidewall of the air-pipe housing 16.

However, the circular pipe 163 is vertically connected with the air-pipe housing 16 with the air inlet 161 having no guiding means for guiding outer air to enter the interior of the air-pipe housing 16, therefore, a comparative large resistance against air and a turbulent air current may be produced at the connecting section of the circular pipe 163 and the air-pipe housing 16 to let dust coming through the inlet 161 hampered by the resistance and the turbulent air current from smoothly flowing along down the inner wall of the air-pipe housing 16, extremely affecting the first stage and the second stage of dust collecting process.

### SUMMARY OF THE INVENTION

The air inlet for a two-stage dust-collecting machine is formed in an annular wall of an air-pipe housing and shaped rectangular in the tangent direction of the air-pipe housing. A rectangular pipe extends out from the rectangular air inlet, and a circular pipe extends out of the rectangular pipe. A current guiding member is formed to extend inward from the rectangular air inlet. Therefore, the rectangular pipe has a comparatively large space for air to flow in for lowering resistance against air and then guided by the current guiding member and flow into the air-pipe housing and along the inner surface of the air-pipe housing to become a helical air current so the sucked air flows smoothly to upgrade the two-grade dust collecting function of the machine.

### BRIEF DESCRIPTION OF DRAWINGS

This invention will be better understood by referring to the accompanying drawings, wherein:

FIG. 1 is a perspective view of a conventional two-stage dust-collecting machine;

FIG. 2 is a partial exploded perspective view of a two-stage dust-collecting machine with an air inlet in the present invention;

FIG. 3 is a perspective view of the air inlet for a two-stage dust-collecting machine in the present invention;

FIG. 4 is an upper view of the air inlet in the present invention; and,

FIG. 5 is a perspective view of the air inlet in the present invention.

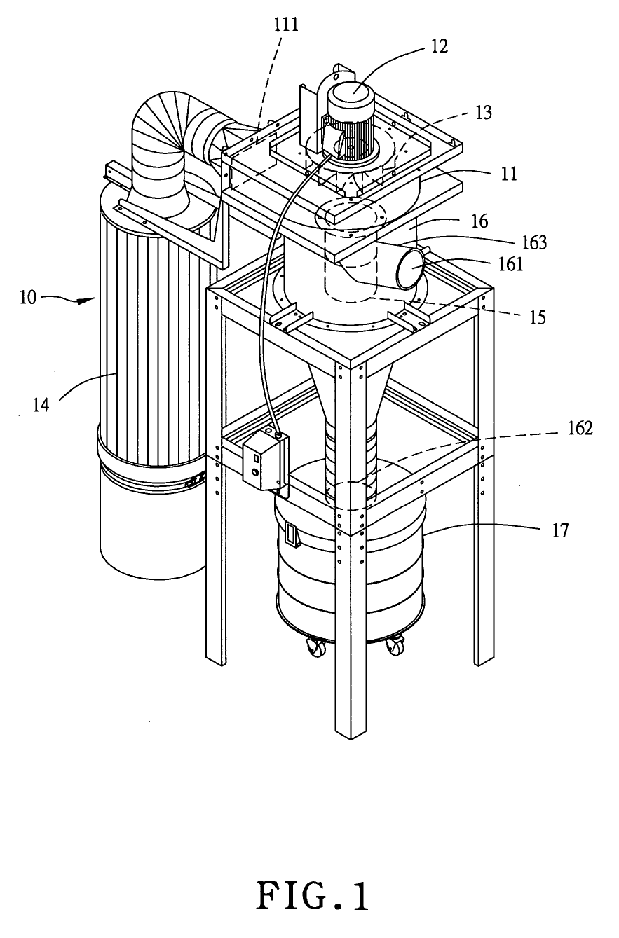

### DETAILED DESCRIPTION OF THE PREFERRED EMBODIMENT

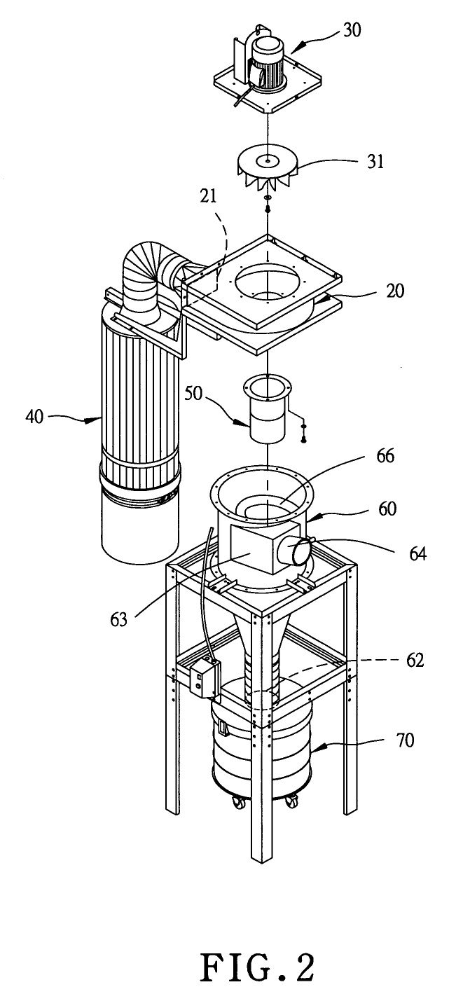

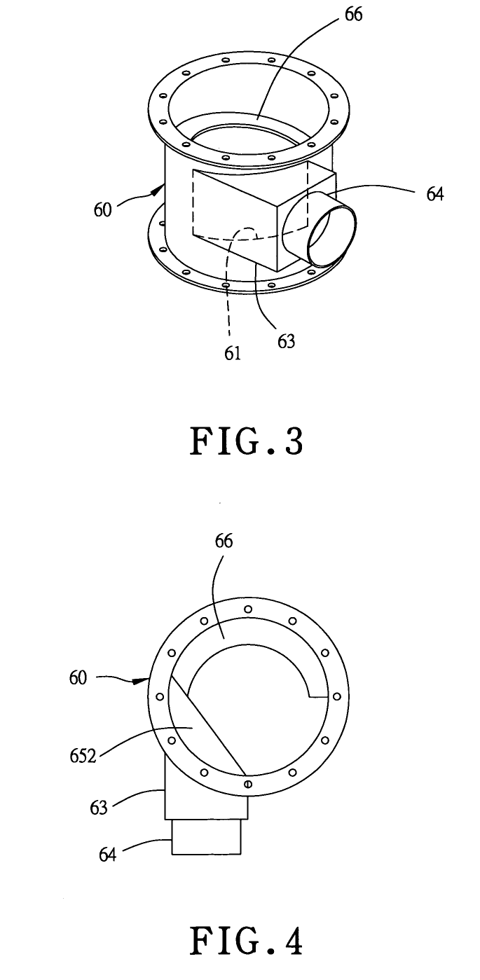

A preferred embodiment of an air inlet for a two-stage dust-collecting machine in the present invention, as shown in FIG. 2, is fixed with a two-stage dust-collecting machine that has almost the same structure of the conventional two-stage dust-collecting machine described above. The two-stage dust collecting machine in the invention includes a fan housing 20, a motor 30, a rotary fan 31, a dust collecting bag 40, an air pipe 50, an air-pipe housing 60 and a dust collecting tank 70 as main components combined together.

The fan housing 20 has a second air exit 21 communicating with the dust bag 40, and the air pipe 50 is connected with the bottom of the fan housing 20 and vertically surrounded by the air-pipe housing 60 with an annular gap, and the air-pipe housing has its upper end fixed with the fan housing 20. Then the air inlet 61 is provided in the annular sidewall of the air-pipe housing 60, and a second air exit 62 is provided in the bottom of the air-pipe housing 60 and connected with the dust collecting tank 70 located below.

The air inlet 61 formed in the air-pipe housing 60 is provided in an tangent direction of the air-pipe housing 60, having a rectangular shape slanting a little, connected with a rectangular pipe 63 extending outward from the rectangular inlet 61, and a circular pipe 64 is provided to extend out of the rectangular pipe 63 for a certain length. Further, a current guiding member 65 is provided to extend slantingly inward from the rectangular inlet 61, consisting of an upper flat wall 652, a flat sidewall 653, a flat bottom wall 654 and a guide exit 651 formed at its inner end. In addition, a helical stop plate 66 is provided on the inner surface of the air-pipe housing 60 and connected with the upper wall 652.

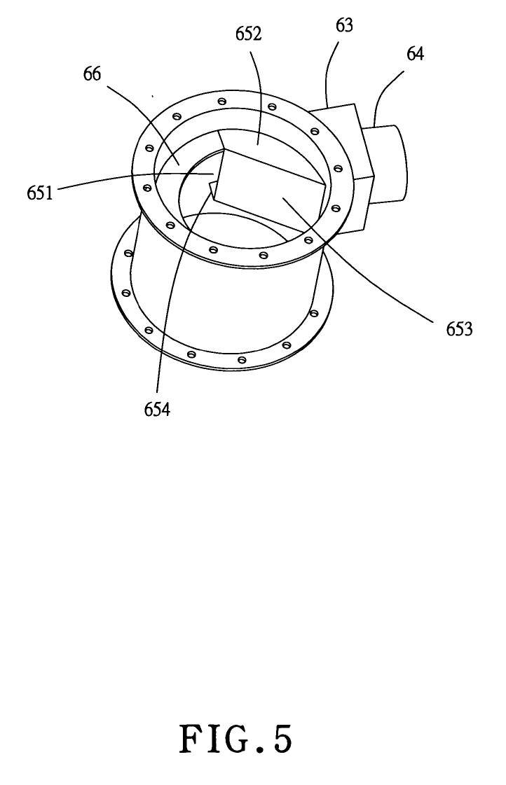

Next, referring to FIGS. 2 and 5, how the two-stage dust collecting machine works is to be described as follows. When the motor 30 is started, it drives the rotary fan 31, forcing the dust sucking route (not shown) in the circular pipe 64 in the air-pipe housing 60 to produce vacuum to let air with dust sucked into the dust sucking route, orderly through the circular pipe 64, the air inlet 161 and the guide exit 651 of the current guiding member 65 into the air-pipe housing 60. Meanwhile, as the rectangular pipe 63 has a comparatively large space for air to flow through, air resistance in the rectangular pipe 63 for the air coming from the circular pipe 64 can be lowered largely. At the same time, the current guiding member 65 with the guide exit 651 are shaped to slant helically for air current flowing in the tangent direction so that the air may flow through the air inlet 161, the current guide pipe 65, the guide exit 651 into the air-pipe housing 60 in a helical direction gradually downward along the inner surface of the air-pipe housing 60. In this way, comparatively big masses of dust may be blown down through the first air exit 63 into the dust collecting tank 70 as the first stage of dust collecting, but comparatively small bits of dust may be blown through the air pipe 15 into the dust bag 40. So it have to be emphasized that the design of the air inlet 161 for the two-stage dust collecting machine can lower resistance against sucked-in air with dust, and produce helical air current for smoothly blowing dust with two stage function, thus upgrading the dust collecting function of the machine.

While the preferred embodiment of the invention has been described above, it will be recognized and understood that various modifications may be made therein and the appended claims are intended to cover all such modifications that may fall within the spirit and scope of the invention.

What is claimed is:

1. A air inlet for a two-stage dust collecting machine, said two-stage dust collecting machine comprising a fan housing, a rotary fan fixed in said fan housing and driven by a motor, said fan housing having a second air exit communicating with a dust bag, an air pipe connected downward with a bottom of said fan housing, an air-pipe housing provided to vertically fit around said air pipe with an annular gap and having its upper end fixed with the bottom of said fan housing, said air inlet provided at an annular sidewall of said air-pipe housing, a first air exit provided in a bottom of said air-pipe housing, a dust collecting tank provided under said first air exit, dust contained in air sucked through said air inlet and then guided into said dust collecting tank for the first stage of duct collecting, dust contained in air sucked through said air pipe, said second air exit and then into said dust bag for the second stage of dust collecting: and,
Said air inlet being a rectangular shape formed in an tangent direction in an vertical sidewall of said air-pipe housing, said rectangular inlet connected with a rectangular pipe extending outward, a circular pipe of a certain length connected with and extending outward from said rectangular pipe, a current guiding member extending inward from said rectangular inlet and having a guide exit in a tangent direction of said air-pipe housing, said rectangular pipe having a comparatively large space to have little resistance against sucked-in air, sucked-in air possible to flow in an helical direction downward along the inner surface of said air-pipe housing by means of guidance of said guide member.

2. The air inlet for a two-stage dust collecting machine as claimed in claim 1, wherein said rectangular inlet is a little slanting to the tangent direction of said air-pipe housing, so said rectangular pipe and said current guiding member are also a little slanting, so sucked-in air may flow downward as a helical current in said air-pipe housing.

3. The air inlet for a two-stage dust collecting machine as claimed in claim 1, wherein said current guiding member is composed of an upper flat wall, a flat sidewall, and a flat bottom wall, and said upper flat wall has its end connected with a helical stop plate extending along an inner surface of said air-pipe housing for guiding sucked-in air to flow in a helical direction.
